(19) United States
(12) Patent Application Publication
(10) Pub. No.: US 2003/0053431 A1
(43) Pub. Date: Mar. 20, 2003

(54) Method for performing handoff in a radio telecommunications network

(76) Inventor: Lila Madour, Kirkland (CA)

Correspondence Address: SANDRA BEAUCHESNE, Ericsson Canada Inc., Patent Department (LMC/I/P), 8400 Decarie Blvd., Town Mount Royal, QC, H4P 2N2, CA

(21) Appl. No.: 10/237,894

(22) Filed: Sep. 10, 2002

Related U.S. Application Data
(60) Provisional application No. 60/317,940, filed on Sep. 10, 2001.

(51) Int. Cl. H04Q 7/00

(52) U.S. Cl. 370/331; 455/440

(57) ABSTRACT

The present invention relates to a method for performing a handoff process in a packet data network. For doing so, the method provides a Mobile Switching Center (MSC) for receiving a handoff required message from a source Base Station (BS). The MSC further generates and sends to a target BS a handoff request message based on the received handoff required message. The target BS receives the handoff request message; and sends a handoff request acknowledge message including a Packet Zone identification (PZID) parameter for identifying a target Packet Core Function (PCF).

### PRIORITY STATEMENT UNDER 35 U.S.C S.119 (e) & 37 C.F.R. S.1.78

This non-provisional patent application claims priority based upon the prior U.S provisional patent applications entitled “METHOD FOR HANDOFF IN A RADIO TELECOMMUNICATIONS NETWORK”, application No. 60/317,940, filed Sep. 10, 2001, in the name of Lila Madour.

### BACKGROUND OF THE INVENTION

1. Field of the Invention

The invention relates to a method for performing handoff in a telecommunications network.

2. Description of the Related Art

Nowadays, in packet data network such as in CDMA2000 networks, whenever a terminal needs to communicate with the wireless IP network, a Point-to-Point Protocol (PPP) session is established between the terminal and a Packet Data Serving Node (PDSN) of the wireless IP network. In a CDMA2000 network, the PDSN is responsible for supporting authentication mechanisms and a configuration option to allow a terminal to receive Mobile IP (MIP) and Simple IP services such as VolP (Voice over IP) or Packet Data Calls. Each time the PPP connection is established, negotiation takes place with regards to authentication, compression, etc, followed by Agent advertisement and a MIP registration request in the case of MIP service. This obviously involves the allocation of a traffic channel to the terminal by a Mobile Switching Center (MSC). The terminal and the PDSN are both ultimately connected to a Base Station that comprises a Packet Core Function (PCF) and a Base Station Controller (BSC). Furthermore, a Radio Access Network (RAN) where the BS is located maintains the PPP connection.

The PPP session consists of a data link protocol between the terminal and the PDSN. The PPP session defines a period during which a particular PPP connection instance is maintained in the open state in both the terminal and PDSN. The PPP session is also maintained during a period when the PPP connection is dormant. A dormant PPP connection is one in which a packet data session has been established, but no data has been exchanged for a long period of time. For example, a terminal may download information from the PDSN, and then spend a considerable amount of time reading it. Under these circumstances, when an inactivity timer expires, the MSC deallocates the radio traffic channel. The PPP session, however, is maintained between the terminal and the PDSN.

If the terminal requests or sends additional data, the dormant PPP connection is reactivated by reallocating a traffic channel so that the data can be transferred. Furthermore, if the terminal hands off from one RAN to another RAN but is still connected to the same PDSN, the PPP connection remains. If a terminal changes PDSN, a new PPP connection is created with the new PDSN.

As regards to handoff, a terminal may be involved for example in a hard handoff. A hard handoff is described as being a handoff that requires the terminal to tune its radio equipment or to reestablish synchronization with a target network. Therefore, the hard handoff requires a certain amount of signaling during and after the hard handoff. During a hard handoff, the terminal is hosting an active packet data session and previous access network information is relayed to a target BS via a MSC. The target RAN forwards its Packet Zone identification (PZID) parameter as well as its own access network ID (system ID (SID) and network ID (NID)) to a serving PDSN. Based on this information the serving PDSN decides to renegotiate PPP connection and send agent advertisements to trigger a MIP registration for the terminal. When the terminal goes dormant, it detects the PZID parameter forwarded from the target BS to the PDSN and originates an Origination message to establish a connection to the PDSN via the target BS.

In fact, a change of PZID is detected by the terminal through the broadcast channel of a BS. This automatically triggers the Origination message from the terminal, which will result in establishment of a connection between the PDSN and a target BS. Reference is now made to FIG. 1, which illustrates an existing dormant handoff signaling following a hard handoff in a packet data network 100 such as a CDMA2000 network and as described in IS-2001 standard. The connections in FIG. 1 are described in IOS (Inter-Operability Specification), which is based on TIA/EIA/IS-2001 “IOS for CDMA2000 Access Network Interfaces”, which is included herewith by reference.

The CDMA2000 network 100 comprises a BS 112 for maintaining a PPP connection between the terminal 104 and the PDSN 110 when the terminal 104 goes dormant. The source BS 112 comprises a Base Station Controller (BSC) 116 and a source PCF 120 connected via an A8/A9 connection.. In FIG. 1, it is assumed the terminal has performed a MIP registration and established a PPP connection with the PDSN 124 but is now dormant and the PPP connection 128 is maintained. Also, it is assumed that the terminal 104 does not have an active voice call in progress.

The dormant terminal 104 detects a change of PZID, SID or NID while monitoring a broadcast channel of the BS 112 and initiates an Origination message 132 with a parameter Data Ready to Send (DRS) set to ‘0’. The BS 112 acknowledges the receipt of the Origination message 132 with a BS 112 Ack Order 136 to the terminal 104. The BS 112 constructs a CM Service Request message 140 and sends it to a MSC 108. Following the reception of the CM Service Request message 140, the MSC 108 sends an Assignment Request message 144 to the target BS 112 for requesting assignment of radio resources. Upon reception of the Assignment Request message 144, the BS 112 establishes an A10/A11 link for registration with mobility indication and the PDSN 124 disconnects an old A10/A11 link with a previous BS (not shown). After the old A10/A11 link has been disconnected, BS 112 sends an Assignment Failure message 152 to the MSC 108 with Cause value indicating Packet Call Going Dormant. The MSC 108 replies to the BS 112 with a Clear Command message 156 with Cause value ‘Do Not Notify Mobile’. Following this, the BS 112 sends a Clear Complete message 160 to the MSC 125. Afterwards, the Packet Data Session remains dormant at step 164.

This signaling following a hard handoff when the terminal goes dormant represents unnecessary extra signaling on both the air interface and the RAN and particularly the BS. Therefore, the invention presents a solution for eliminating extra signaling on precious air interface and RAN resources.

### SUMMARY OF THE INVENTION

It is therefore one broad object of this invention to provide a method for performing a handoff process in a packet data network, the method comprising steps of:

receiving at a serving Mobile Switching Center (MSC) a handoff required message from a source Base Station (BS);

generating at the MSC a handoff request message based on the received handoff required message;

sending to a target BS the handoff request message;

receiving at the target BS the handoff request message; and

sending from the target BS a handoff request acknowledge message including a Packet Zone identification (PZID) parameter for identifying a target Packet Core Function (PCF).

It is also another object of the present invention to provide a target Base Station (BS) for receiving a handoff request message from a serving Mobile Switching Center (MSC), the target BS being capable of:

sending a handoff request acknowledge message to the MSC, the handoff request acknowledge message including a Packet Zone identification (PZID) parameter for identifying a target Packet Core Function (PCF).

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is illustrating an existing dormant handoff signaling following a hard handoff in a packet data network 100 such as a CDMA2000 network and as described in IS-2001 standard;

FIG. 2 is illustrating a terminal having an active packet data session in a packet data network in accordance to the present invention;

FIG. 3 is illustrating a hard handoff process in a packet data network in accordance to the present invention; and

FIG. 4 is illustrating a list of PZIDs in accordance to the invention.

### DETAILED DESCRIPTION OF THE PREFERRED EMBODIMENTS

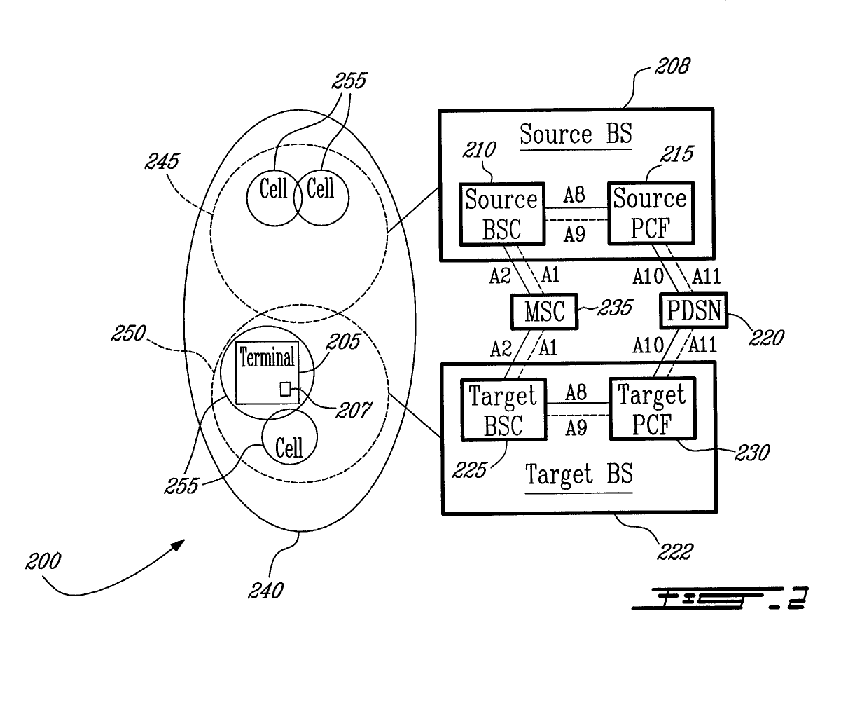

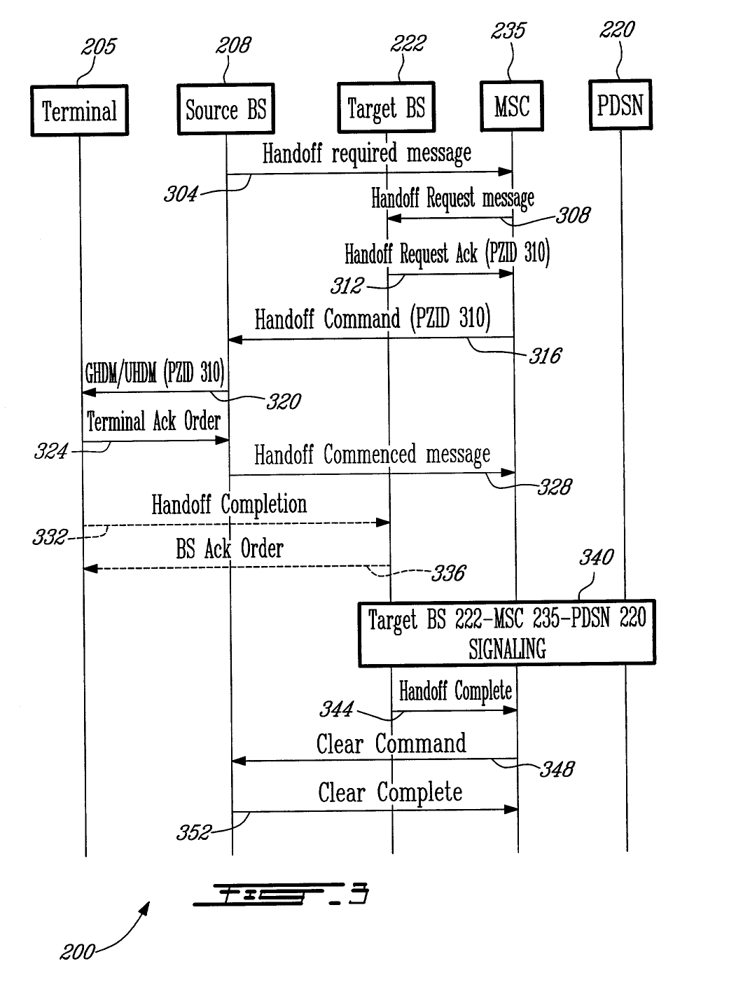

Reference is now made to FIG. 2, which illustrates a terminal 205 having an active packet data session in a packet data network 200 and further to FIG. 3, which illustrates a hard handoff process in the packet data network 200 in accordance to the present invention. The packet data network 200 may be a CDMA2000 network, a Universal Mobile Telecommunications System (UMTS) or any wireless packet data system having link layer for performing handoff process.

In FIG. 2 and FIG. 3 reference is made to a CDMA2000 network. Therefore, for now on the packet data network is referred as being a CDMA2000 network. In FIG. 2 and FIG. 3, it is assumed that the terminal 205 has performed a Mobile IP (MIP) registration and established a PPP connection with a PDSN 220. It is also assumed that the terminal 205 has an activate packet data session in the CDMA2000 network.

The CDMA2000 network 200 comprises at least one service area served by a MSC for switching capabilities. Each service area comprises at least a Packet Zone (PZ) identified by a Packet Zone identification (PZID) parameter. Each packet zones of the CDMA2000 network comprises at least one cell 255 in which the terminal 205 may roam. In FIG. 2, a MSC 235 serves the service area 240.

The MSC 235 is connected via an A1/A2 connection to a source BS 208 and via another A1/A2 connection to a target BS 222. The source BS 208 and the target BS 222 are each connected to a PZ. The source BS 208 is connected to PZ 245 while the target BS is connected to PZ 250. The source BS 208 comprises a source Base Station Controller (BSC) 210 and a source Packet Core Function (PCF) 215 that are connected via an A8/A9 connection. The target BS 222 comprises a target BSC 225 and a PCF 230 that are also connected via an A8/A9 connection. Furthermore, a BSC and a PCF may be collocated in a BS or used as standalone network elements. On one hand, the source BS 208 provides signaling to the terminal 205 when it is located in its Packet Zone 245. On the other hand, the target BS 222 provides signaling the terminal when the terminal hands off to its PZ 250. The source BS 208 and the target BS 222 are ultimately connected via an A10/A11 connection to the PDSN 220 for providing packet data services to the terminal 205. The packet data services can be services such as Voice over IP (VoIP), packet data calls or any services that can be provided in a packet data network such as the CDMA2000 network 200.

In FIG. 3, a message received at a BS (source or target) can therefore be received at its BSC or at its PCF. More importantly, a message that originates from a BS may require a signaling between its BSC 210 and its source PCF or may be sent without a need of a signaling. However, the signaling between these a BSC and a PCF is omitted for clarity reasons.

Each PZ of FIG. 2 in the CDMA2000 network 200 is uniquely identified by a Packet Zone identification (PZID) parameter within a particular System ID/Network ID (SID/NID) area. Therefore, a combined PZID/SID/NID consists of an access network ID (ANID) and is unique to a BS, since each BS is connected to a unique PZ. More precisely, a PZID is known by a PCF that is collocated with a BSC in the BS or that is used as a standalone network element. The PCF is allowed to communicate that information to other network elements in the CDMA2000 network.

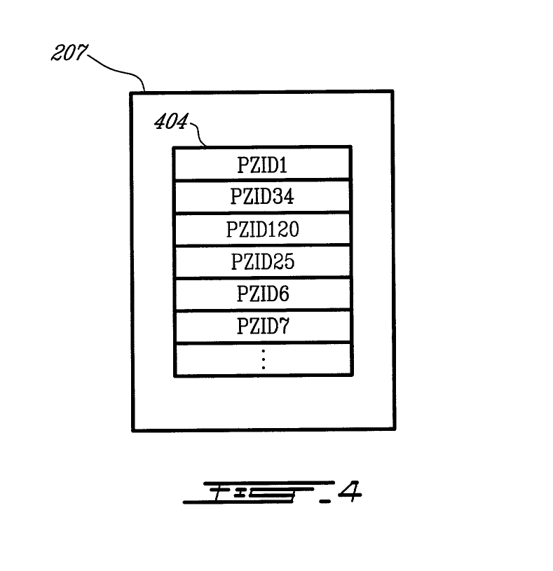

The terminal 205 can be a mobile station, a mobile telephone a personal data application, or any mobile equipment that can receive signal from the CDMA2000 network or a packet data network and that can allow a user that equipment to communicate via a packet data network. The terminal 205 comprises an internal memory 207 for storing a list of PZIDs 404 received from the packet data network 200. FIG. 4 illustrates the list of PZIDs 404 in accordance to the present invention. The list 404 contains at least one PZID of a PZ visited by the terminal 205. In addition, the list of PZIDs 404 may contain a maximum of PZIDs defined by an Operator of the CDMA2000 network 200.

Based on a terminal's 205 report that the terminal 205 has crossed a network specified threshold for signal strength, changed to a different ANID or for other reasons, the source BS 208 recommends a hard handoff to one or more cells 255 in PZ 250 of the target BS 222. For that purpose, the source BSC 210 sends a Handoff Required message 304 including a list of cells to the MSC 235. The Handoff Required message 304 comprises a PreviousANID (PANID) information. Following the reception of the Handoff Required message 304, the MSC 235 sends to the target BS 222 a Handoff Request message 308 including the PANID information and a hard handoff indicator, which acts as a Handoff Type element in the message indicating hard handoff. Upon reception of the Handoff Request message 308, the target BS 222 sends to the MSC 235 a Handoff Request Ack 312 including the PZID 310 of the target PCF 230 parameter in response to the Handoff Request message 308. Next, the MSC 235 sends to the source BS 208 a Handoff Command message 316 including the PZID 310 of the target PCF 230 received from the target BS.

As a result of the handoff process, the terminal 205 has to be served by the target BS 222 and ultimately by the PDSN 220 for having packet data services. For that reason, the source BS 208 sends to the terminal 205 a General Handoff Direction Message or a Universal Handoff Direction Message (GHDM/UHDM) 320 including the PZID 310 of the target PCF 230. Upon reception of the GHDM/UHDM message 320, the terminal 205 stores in the list of the PZIDs 404 the PZID 310 of the target PCF 230 and updates the list of PZIDs 404 in its memory 207 with the PZID 310 of the target PCF 230. The GHDM/UHDM 320 allows the terminal 205 to initiate a connection with the target BS 222. Next, the terminal 205 replies to the GHDM/UHDM message 340 of the source BSC 210 with a Terminal Ack Order 324. The source BS 208 receives the Terminal Ack Order 324 from the terminal 205 and sends to the MSC 235 a Handoff Commenced message 328. The Handoff Commenced Message 328 is sent for notifying the MSC 235 that the terminal 205 has been ordered to move to the target BS 222 for completing the handoff process.

Since the terminal 205 has to move to the target BS 222 the terminal 205 needs to initiate a connection with the target BS 222. For doing so, the terminal 205 uses the GHDM/UHDM message 320 for sending to the target BS 222 a Handoff Completion message 332. The target BS 222 further replies to the Handoff Completion message 332 by sending a BS Ack Order 336. After receiving the BS Ack Order 336, the terminal 205 may go dormant (dormant packet data session). Upon reception of the Handoff Completion message from the terminal 205, the target BS 222 initiates a signaling 340 that involves the MSC 235, and the PDSN 220. During the signaling 340, the target BS 222 uses the PANID information and for establishing an A10/A11 connection with the PDSN 220. The PDSN 220 further disconnects any previous A10/A11 connection. In the present case, the PDSN 220 was connected to the source BS 208.

The handoff process for the terminal 205 is not completed until the source BS 208 sends to the MSC 235 a Clear Complete message 352. The Clear Complete message 385 is sent to the MSC 235 in response to a Clear Command message 348 that was originated from the same MSC 235.

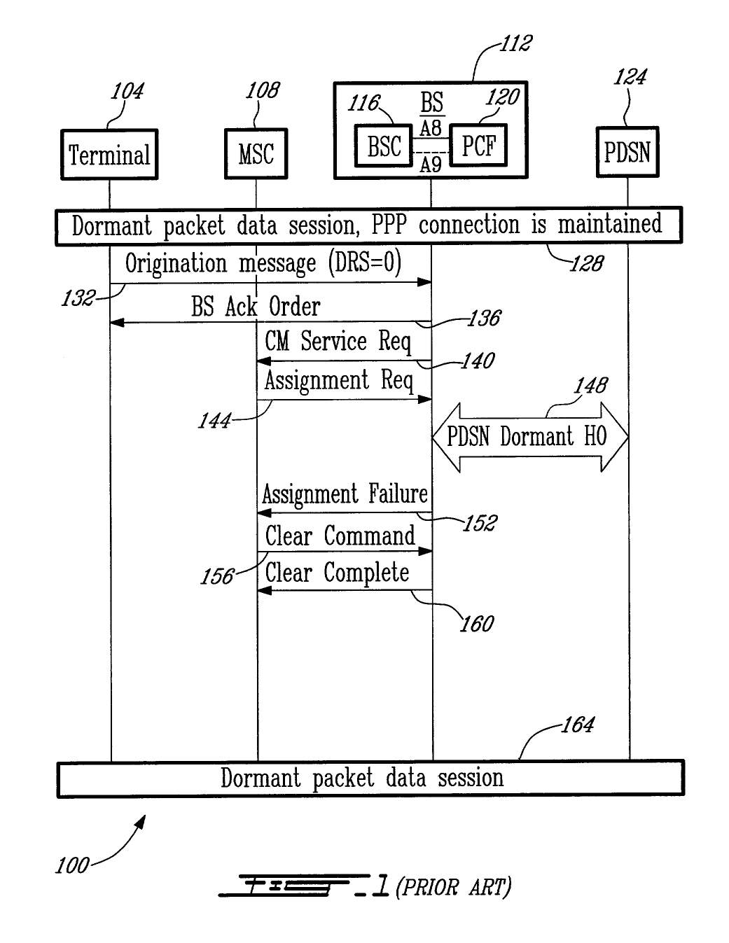

When the terminal 205 successfully hands off as described above and after the packet data session it is hosting goes dormant, the traffic channel between the terminal 205 and the source BS 208 is released by the MSC 235. On returning to dormancy at the target BSC 225, the terminal 205 monitors a broadcast channel of the target BS 222 and receives the PZID 310 of the target PCF. The broadcast channel of the target BS 222 communicates information such as a system identification SID parameter or any other parameters known by the target BS 222. The terminal 205 compares the PZID 310 received over the broadcast channel and realizes that the PZID 310 is the same of one PZID stored in the list of PZIDs 404. More precisely, the PZID 310 previously stored in the list of PZID 404, upon reception of the GHDM/UHDM at the terminal 205, is the same PZID 310 broadcasted by the target BS 222. Since the broadcasted PZID 310 is equal to the PZID 310 stored in the list of PZIDs 404 of the terminal 205, the terminal 205 does not originates an Origination message (not shown) to the target BS 222. Consequently, a signaling following a hard handoff such as the signaling described in FIG. 1 is not performed. Also, if the list of PZIDs 404 is full, the terminal 404 simply delete an older PZID previously stored in the list 404 with a first in first out procedure.

It can be understood that some messages and therefore some parameters sent from the terminal 205 to the CDMA2000 network 200 and vice versa are not mentioned nor described for clarity reasons. Also some messages and therefore some parameters sent between network elements in the CDMA2000 network 200 are omitted for clarity reasons.

Although several preferred embodiments of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for performing a handoff process in a packet data network, the method comprising steps of:
receiving at a serving Mobile Switching Center (MSC) a handoff required message from a source Base Station (BS);
generating at the MSC a handoff request message based on the received handoff required message;
sending to a target BS the handoff request message;
receiving at the target BS the handoff request message; and
sending from the target BS a handoff request acknowledge message including a Packet Zone identification (PZID) parameter for identifying a target Packet Core Function (PCF).

2. The system of claim 1, wherein the step of sending from the target BS a handoff request acknowledge message including a Packet Zone identification (PZID) parameter for identifying a target PCF further includes steps of:
receiving at the MSC the handoff acknowledge message;
sending from the MSC to the source BS a handoff command including the PZID parameter identifying the target PCF;
receiving at a source BS the handoff command message, the handoff command message including the PZID parameter for identifying the target PCF;
sending from the source BS a general handoff message, the general handoff message including the PZID parameter for identifying the target PCF;
receiving at the terminal the general handoff message;
storing in a memory of the terminal the PZID identifying the target PCF;
updating in the memory a list of PZIDs, the memory being updated using the PZID identifying the target PCF; and
sending from the terminal a terminal acknowledge message to the source BS.

3. A target Base Station (BS) for receiving a handoff request message from a serving Mobile Switching Center (MSC), the target BS being capable of:
sending a handoff request acknowledge message to the MSC, the handoff request acknowledge message including a Packet Zone identification (PZID) parameter for identifying a target Packet Core Function (PCF).

4. The target BS for receiving a handoff request of claim 3, the target BS further being capable of:
sending a handoff command message to a source BS, the handoff command message including the PZID parameter identifying the target PCF.

5. The target BS for receiving a handoff request of claim 3, the target BS further being capable of:
establishing a A10/A11 connection with a PDSN; and
sending a handoff complete message to the MSC.
